(19) United States
(12) Patent Application Publication
(10) Pub. No.: US 2014/0268731 A1
(43) Pub. Date: Sep. 18, 2014

(54) LOW BAY LIGHTING SYSTEM AND ASSOCIATED METHODS

(71) Applicant: LIGHTING SCIENCE GROUP CORPORATION, Satellite Beach, FL (US)

(72) Inventors: Fredric S. Maxik, Indialantic, FL (US); David E. Bartine, Cocoa, FL (US); Robert R. Soler, Cocoa Beach, FL (US); Mark Andrew Oostdyk, Cape Canaveral, FL (US); Addy S. Widjaja, Palm Bay, FL (US); Ran Zhou, Melbourne, FL (US)

(73) Assignee: LIGHTING SCIENCE GROUP CORPPORATION, Satellite Beach, FL (US)

(21) Appl. No.: 13/837,643

(22) Filed: Mar. 15, 2013

(51) Int. Cl. F21K 99/00

(52) U.S. Cl. CPC F21K 9/50; F21K 9/56
USPC 362/230; 362/293

(57) ABSTRACT

A low bay lighting system which may include a fixture housing and a plurality of light sources disposed on a mounting surface in the fixture housing. The low bay lighting system may also include a power supply and an optic that is configured for emission of glare-inducing wavelength light at non-glare-inducing angles. The non-glare-inducing angles may be measured from a horizontal axis running through a medial portion of the mounting surface of the fixture housing. One or more of the plurality of light sources may be configured to emit light having a wavelength range within an anti-glare wavelength range. The light emitted at glare-inducing angles may have a wavelength range substantially within the anti-glare wavelength range.

### RELATED APPLICATIONS

This application is related to U.S. patent application Ser. No. 13/234,604 filed Sep. 16, 2011, titled Remote Light Wavelength Conversion Device and Associated Methods, the entire contents of which are incorporated herein by reference. This application is also related to U.S. patent application Ser. No. 13/792,354 filed Mar. 11, 2013, titled Adaptive Anti-Glare Light System and Associated Methods, the entire contents of which are incorporated herein by reference. This application is also related to U.S. patent application Ser. No. 13/775,936 filed Feb. 25, 2013, titled Adaptive Light System and Associated Methods, the entire contents of which are incorporated herein by reference. This application is also related to Ser. No. 13/681,522 filed Nov. 20, 2012, titled Illumination and Grow Light System and Associated Methods, the entire contents of which are incorporated herein by reference.

### FIELD OF THE INVENTION

The present invention relates to systems and methods for emitting light. More specifically, the present invention relates to a lighting system for emitting both anti-glare and glare inducing light.

### BACKGROUND OF THE INVENTION

A luminaire is an electrical device used to create light by the use of an electric lamp system, outputting light into an environment. A luminaire is also able to control and distribute the light it produces. Luminaires can be used in both indoor or outdoor applications.

Light emitted from a luminaire may include glare inducing light that can impact the ability of a user to observer an illuminated area. Glare can reduce visibility and partially blind a driver leading to unsafe conditions which can contribute to accidents. Attempts to solve the problem of emitting light without blinding a user with glare typically make use of a reflector so that the light source is not readily visible. This solution however, reduces the amount of light that may be delivered by the light source because of the use of such reflectors.

An anti-glare assembly for a luminaire is disclosed, for example, in European Patent Application EP 2,423,566 by Morgan. The Morgan reference uses lamina in the assembly of the main body of the luminaire arranged and configured so that the luminaire may emit light that does not cause glare.

The prior art does not emit anti-glare light by altering the characteristics of the light's wavelength or the angle of emission of the light. Therefore, a need exists to provide a device and system that can produce light efficiently while avoiding the glare generated by a direct viewing of a light source by altering the wavelength of the light and/or the angle of emission of the light.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

Provided herein are systems and methods that address the above-identified problems. More specifically, embodiments of the present invention advantageously provide a method and system for a low bay luminaire or lighting system that reduces or eliminates glare. The embodiments of the present invention also provide a luminaire that is easy to assemble and less expensive than other luminaires. The systems and methods according to an embodiment of the present invention also advantageously provides efficiently produced light that reduces or eliminates glare based on an angle of emission and/or by altering the wavelength at which the light is emitted.

These and other features, benefits and advantages are provided by a low bay lighting system which may include a fixture housing, a plurality of light sources disposed on a mounting surface in the fixture housing, a power supply and an optic that is configured for emission of glare-inducing wavelength light at non-glare-inducing angles. The non-glare-inducing angles may be measured from a horizontal axis running through a medial portion of the mounting surface of the fixture housing. One or more of the plurality of light sources may be configured to emit light having a wavelength range within an anti-glare wavelength range. The light emitted at glare-inducing angles may have a wavelength range substantially within the anti-glare wavelength range.

The anti-glare-inducing angles measured from a horizontal axis for the anti-glare wavelength light may be within the range from about 0 degrees to about 25 degrees, and the wavelength of the anti-glare light may be within the range from about 495 nm to about 750 nm.

The fixture housing may include a wall forming an internal cavity that is configured to permit an electrical component to be positioned therein. The lighting system may further include a heat sink structure. The power supply, the electrical component, and/or the plurality of light sources may be thermally coupled with the heat sink structure. The glare-inducing wavelength light may be polychromatic light and may include light having a wavelength range within the glare-inducing wavelength range.

The optic may be configured to facilitate the transmission of light emitted in the anti-glare wavelength range at glare inducing angles. The plurality of light sources may be light-emitting diodes (LEDs).

The system may include a color conversion layer configured to convert light having a wavelength within the glare-inducing wavelength range to a converted light having a wavelength within the anti-glare wavelength range. The color conversion layer may be positioned adjacent to a portion of an inner surface of the optic.

A method aspect of the present invention is for emitting anti-glare light using a low bay lighting system. The method includes operating the light source to emit light having a wavelength range within an anti-glare wavelength range at glare-inducing angles. The method may further include operating the light source to emit light having a wavelength range within a glare-inducing wavelength range at non-glare-inducing angles.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use a lighting system in accordance with embodiments of the present invention. In the drawings, like reference numbers indicate identical or functionally similar elements.

FIG. 1 is a top plan view of a low bay lighting system according to an embodiment of the present invention.

FIG. 2 is a bottom perspective view of the lighting system illustrated in FIG. 1.

FIG. 3 is a side elevation view of an optic of the lighting system illustrated in FIG. 1.

FIG. 4 is a top perspective view of a low bay lighting system according to an embodiment of the present invention.

FIG. 5 is a bottom perspective view of the low bay lighting system illustrated in FIG. 4.

FIG. 6 is a top plan view of the low bay lighting system illustrated in FIG. 4.

FIG. 7 is a side elevation view the low bay lighting system illustrated in FIG. 4.

FIG. 8 is another side elevation view the low bay lighting system illustrated in FIG. 4.

FIG. 9 is a bottom plan view the low bay lighting system illustrated in FIG. 1.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art will realize that the following embodiments of the present invention are only illustrative and are not intended to be limiting in any way. Other embodiments of the present invention will readily suggest themselves to such skilled persons having the benefit of this disclosure. Like numbers refer to like elements throughout.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Referring now to FIGS. 1-3, a low bay lighting system 10 according to an embodiment of the present invention is disclosed. The terms low bay lighting system and luminaire are used interchangeably. The luminaire 10 may include a fixture housing 3 for housing the elements of the luminaire. The luminaire 10 may include a plurality of light sources 4 disposed on a mounting surface in the fixture housing 3 and a power supply (not shown). The light source may be an LED. Those skilled in the art, however, will appreciate that the luminaire 10 according to an embodiment of the present invention may be used in connection with any type of light source 4 such as, for example, incandescent lights, fluorescent lights, lasers, halogen lights, or any other type of light source. The luminaire 10 may also include a heat sink 2 and a wall mount 5. The luminaire 10 may further include an optic 1 that is configured for emission of glare inducing wavelength light at non-glare inducing angles. The non-glare inducing angles are measured from a horizontal axis running through a medial portion of the mounting surface of the fixture housing 3.

The luminaire 10 according to an embodiment of the present invention may also, or alternatively, include at least one of the plurality of light sources 4 that is configured to emit light having a wavelength range within an anti-glare wavelength range. The luminaire 10 may further be configured so that light emitted from any of the light sources at glare-inducing angles may be emitted substantially within the anti-glare wavelength range. For example, light with spectra that correspond to a wavelength that equates to blue or ultra violet (UV) light may be not be emitted or only emitted at non-glare-inducing angles since these wavelengths are known to cause glare.

Accordingly, embodiments of the luminaire 10 according to the present invention may advantageously emit light that reduces or eliminates glare in a low bay application such as, for example, in a garage (such as a residential garage) or in any other application that requires illumination in an area having a ceiling that is not considered a high bay. For example, such ceilings may range from between about 8 feet high to about 15 feet high. The embodiments of the luminaire 10 according to the present invention advantageously prevent or reduce glare to observers of light emitted therefrom that may be entering and exiting the low bay area. For example, a driver entering or exiting a low bay area may, when equipped with luminaires according to the prior art, have been partially blinded by light emitted from luminaires of the prior art. The luminaire 10 according to the present invention, however, advantageously reduces or eliminates such glare. More particularly, the luminaire 10 according to an embodiment of the present invention may include an optic that causes light emitted from the light source to be emitted at non-glare inducing angles. Alternately, or in addition, the luminaire according to an embodiment of the present invention may emit light that is considered anti-glare light, which may be emitted within wavelengths having an anti-glare wavelength range. An anti-glare wavelength range is preferably defined as light having a wavelength that, when emitted, does not cause glare to an observer of the light, regardless of the angle at which the light is emitted.

A skilled artisan will appreciate that the luminaire 10 according to an embodiment of the present invention may be provided with the optic 1 that causes light emitted from the light source to be emitted at a non-glare inducing angle, or that the luminaire 10 may be provided having a light source that emits light having a wavelength that is within an anti-glare wavelength range. Further, the skilled artisan will appreciate that the luminaire 10 according to embodiments of the present invention may be provided with both the optic 1 that causes light emitted from the light source to be emitted at a non-glare inducing angle, as well as with a light source that emits light within the anti-glare wavelength range.

Skilled artisans will further appreciate that the luminaire 10 according to an embodiment of the present invention may include multiple optics. In such an embodiment, each optic may be configured to emit anti-glare light and may be further configured so that any glare-inducing light emitted is emitted substantially within the anti-glare wavelength range and/or angles known not to cause or induce glare.

The optic 1 of the low bay lighting system 10 according to embodiments of the present invention may cause light emitted from the light source to be emitted as anti-glare inducing light where the angles are measured from a horizontal axis and the light, after passing through the optic 1, may be emitted substantially between 0° to 25°. In another embodiment, the light may be emitted substantially between 0° to 15°. In a further embodiment, the light may be emitted between 0° to 10°. Skilled artisans will appreciate that light of various wavelengths may not have the same glare causing effects. Therefore, the angle at which light may be emitted to avoid glare may vary depending on the wavelength of the light emitted. Those skilled in the art will also appreciate that the above-referenced angles are exemplary in nature and not meant to be limiting. For example, a low bay lighting system 10 adapted to be positioned in area having a higher ceiling may emit light at greater angles measured from horizontal while still not producing glare inducing light. Therefore, the present invention contemplates that light may be emitted at angles up to 45° for a luminaire 10 that may be positioned in a low bay application in an area having a higher ceiling.

The low bay lighting system 10 may further emit anti-glare light where the wavelength of the light may be within the range from about 495 nm to about 750 nm. Again, those skilled in the art will appreciate that these ranges are exemplary in nature and not meant to be limiting. More particularly, the low bay lighting system 10 according to embodiments of the present invention may provide light that is emitted from the light source in any non-glare inducing wavelength. Further, those skilled in the art will appreciate that a conversion coating may be provided to convert a wavelength of a source light having a source wavelength range into a converted light having a converted wavelength range. In this example, the source light may have a glare inducing wavelength range, and the converted light may have a non-glare (or anti-glare) wavelength range. A conversion coating may, for example, be positioned in any number of places. More particularly, the conversion coating may be applied directly to the light source. Alternately, the conversion coating may be applied to the optic 1. In such an embodiment, the conversion coating may be applied to an internal surface of the optic 1, or an external service of the optic.

The low bay lighting system 10 may also include a cavity (not shown) formed in the fixture housing 3. The cavity may be configured to permit an electrical component to be positioned inside the cavity. The cavity may be utilized to house the power supply and/or an electronic sensor. Skilled artisans may appreciate, that the cavity may also be used to house any electronic or electrical component subject to relative size and space constraints of the cavity. The sensor that is housed within the cavity may, for example, be any type of sensor including, but not limited to, an occupancy sensor, a motion sensor, a camera, or any other type of sensor suitable for detecting the presence or absence of any type of object within a target area. Additional information regarding the use of sensors in connection with luminaires is provided in U.S. Provisional Patent Application No. 61/644,152 filed on May 8, 2012 and titled Self-Calibrating Multi-Directional Security Luminaire and Associated Methods, as well as U.S. patent application Ser. No. 13/464,345 filed on May 4, 2012 and titled Occupancy Sensor and Associated Methods, and U.S. patent application Ser. No. 13/403,531 filed on Feb. 12, 2012 and titled Configurable Environmental Condition Sensing Luminaire, System and Associated Methods, the contents of each of which are incorporated herein by reference.

The low bay lighting system 10 may include a heat sink 2. The power supply, an electrical component and the plurality of light sources may be thermally coupled with the heat sink structure by direct contact, a thermal adhesive or other technique known to those of skill in the art. In another embodiment of the invention, the power supply may be thermally coupled from the plurality of light sources. Thermal management capability of the low bay lighting system 10 according to an embodiment of the present invention may be provided by one or more heat sinks 2. More specifically, the heat sink 2 may be configured to be thermally coupled to elements of the low bay lighting system 10 so as to increase the thermal dissipation capacity of the luminaire. The heat sink 2 may include a number of fins configured to provide a larger surface area than may otherwise be provided by the surface of the luminaire 10 to dissipate heat. The configuration of the fins may be any number of configurations suitable for providing enhanced surface area to move heat away from the light source, or, in the case where the light source is provided by an LED package, away from the LED according to the direction of the incorporated references. Without limitation, portions of a heat sink 2 may include one or more fins that may be coupled with and positioned substantially perpendicular the light source as illustrated, for example, in FIG. 2.

The light source of the low bay lighting system 10 may emit glare-inducing wavelength light where the light is polychromatic and includes light having a wavelength range within the glare-inducing wavelength range. The luminaire 10 may also include an optic 1 that maybe be configured to facilitate the transmission of light emitted from the light source in the anti-glare wavelength range at glare inducing angles.

As indicated above, the low bay lighting system 10 may further include a color conversion layer configured to convert light having a wavelength within the glare-inducing wavelength range to a converted light having a wavelength within the anti-glare wavelength range. The color conversion layer may be positioned adjacent to a portion of an inner surface of the optic. The color conversion layer may convert light from a wavelength substantially between 380 nm-495 nm to anti-glare light with a wavelength substantially between 495 nm to 750 nm.

Skilled artisans may appreciate that the conversion layer may enable the conversion of light from a source light source into a light of a different wavelength range. These wavelength conversion coatings may sometimes applied to the optic in a location in line with the light projected from a light source. In some instances the conversion layer may be applied to the light source itself.

The color conversion layer may be formed of any material capable of receiving a source light within a first wavelength range and emitting a converted light within a second wavelength range. Types of materials include, but are not limited to, phosphors, luminescents, quantum dot materials, and dyes. All other non-recited materials capable of performing such a color conversion are contemplated and included within the scope of the invention. Additional information regarding conversion of light using color conversion coatings may be found in U.S. patent application Ser. No. 13/234,371 filed on Sep. 16, 2011 and titled Color Conversion Occlusion and Associated Methods, as well as U.S. patent application Ser. No. 13/305,434 filed on Nov. 28, 2011 and titled Remote Lighting Device and Associated Methods, and U.S. patent application Ser. No. 13/234,604 filed on Sep. 16, 2011 and titled Remote Light Wavelength Conversion Device and Associated Methods, the entire contents of each of which are incorporated herein by reference.

Additional views of the low bay lighting system 10 according to embodiments of the present invention are depicted in FIGS. 4-9. These figures depict the design of the low bay lighting system 10 according to the present invention.

A method aspect of the present invention is for emitting anti-glare light using a low bay lighting system that includes a light source and an optic. The method may include the steps of operating the light source to emit light having a wavelength range within an anti-glare wavelength range at glare-inducing angles. The method may further include operating the light source to emit light having a wavelength range within a glare-inducing wavelength range at non-glare-inducing angles. In an embodiment of the present invention wherein the lighting system further comprises a color conversion layer applied to an inner surface of the optic, the method may further include the steps of emitting light so as to be incident upon the color conversion layer, and emitting a converted light from the color conversion layer having a wavelength range within an anti-glare wavelength range at a glare-inducing angle.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed.

What is claimed is:

1. A low bay lighting system comprising:
a fixture housing;
a plurality of light sources disposed on a mounting surface in the fixture housing;
a power supply;
an optic that is configured for emission of a glare-inducing wavelength light at non-glare-inducing angles;
wherein the non-glare-inducing angles are measured from a horizontal axis running through a medial portion of the mounting surface of the fixture housing;
wherein at least one of the plurality of light sources is configured to emit light having a wavelength range within an anti-glare wavelength range; and
wherein light emitted at glare-inducing angles has a wavelength range substantially within the anti-glare wavelength range.

2. A low bay lighting system according to claim 1 wherein the anti-glare-inducing angles measured from a horizontal axis for the anti-glare wavelength light is within the range from about 0 degrees to about 25 degrees.

3. A low bay lighting system according to claim 1 wherein the wavelength of the anti-glare light is within the range from about 495 nm to about 750 nm.

4. A low bay lighting system according to claim 1 wherein the fixture housing comprises a wall forming an internal cavity that is configured to permit an electrical component to be positioned therein.

5. A low bay lighting system according to claim 4 wherein the lighting system further comprises a heat sink structure; and wherein at least one of the power supply, the electrical component, and the plurality of light sources is thermally coupled with the heat sink structure.

6. A low bay lighting system according to claim 5 wherein the glare-inducing wavelength light is polychromatic light including light having a wavelength range within the glare-inducing wavelength range.

7. A low bay lighting system according to claim 1 wherein the optic is configured to facilitate the transmission of light emitted in the anti-glare wavelength range at glare inducing angles.

8. A low bay lighting system according to claim 1 wherein at least one of the plurality of light sources is a light-emitting diode (LED).

9. A lighting system according to claim 1 further comprising a color conversion layer configured to convert light having a wavelength within the glare-inducing wavelength range to a converted light having a wavelength within the anti-glare wavelength range; wherein the color conversion layer is positioned adjacent to a portion of an inner surface of the optic.

10. A low bay lighting system comprising:
a fixture housing;
a power supply;
an optic having an inner surface;
a light source disposed on a mounting surface of the fixture housing; and
a color conversion layer positioned adjacent to a portion of the inner surface of the optic,
wherein the color conversion layer is configured to convert light having a wavelength within a glare-inducing wavelength range to a converted light having a wavelength within an anti-glare wavelength range.

11. A low bay lighting system according to claim 10 wherein the color conversion layer is configured to convert light having a wavelength within the range from about 380 nm to about 495 nm to a converted light having a wavelength within the range from about 495 nm to about 750 nm.

12. A low bay lighting system according to claim 10 wherein a proportion of the emitted light converted by the color conversion layer to light having an anti-glare wavelength is greater at glare-inducing angles as compared to non glare-inducing angles; and wherein the angle of emitted light is measured from a vertical axis passing through a medial portion of the mounting surface of the fixture housing.

13. A low bay lighting system according to claim 10 wherein the color conversion layer is positioned to convert light within a anti-glare-inducing angle range measured from a plane defined by a horizontal axis from about 0 degrees to about 25 degrees

14. A low bay lighting system according to claim 10 wherein the lighting system further comprises a heat sink structure; and wherein the power supply is thermally decoupled from the plurality of light sources.

15. A low bay lighting system according to claim 10 wherein the light source comprises an LED.

16. A low bay lighting system according to claim 10 wherein the fixture housing further comprises a wall having at least one cavity that is configurable to permit an electronic sensor to be positioned therein.

17. A low bay lighting system according to claim 10 wherein the color conversion layer is selected from the group consisting of phosphors, quantum dots, and dyes.

18. A low bay lighting system according to claim 10 wherein the light source comprises a polychromatic light source.

19. A method of emitting anti-glare light using a low bay lighting system that includes a light source and an optic, the method comprising the steps of
operating the light source to emit light having a wavelength range within an anti-glare wavelength range at glare-inducing angles; and
operating the light source to emit light having a wavelength range within a glare-inducing wavelength range at non-glare-inducing angles.

20. A method according to claim 19 wherein the lighting system further comprises a color conversion layer applied to an inner surface of the optic; the method further comprising the steps of:
emitting light so as to be incident upon the color conversion layer; and
emitting a converted light from the color conversion layer having a wavelength range within an anti-glare wavelength range at a glare-inducing angle.
